(19) United States
(12) Patent Application Publication
(10) Pub. No.: US 2015/0171698 A1
(43) Pub. Date: Jun. 18, 2015

(54) Synchronous Reluctance Motor and Underwater Pump

(71) Applicant: KSB Aktiengesellschaft, Frankenthal (DE)

(72) Inventor: Sven Urschel, Kirchheim an der Weinstrasse (DE)

(21) Appl. No.: 14/390,487

(22) PCT Filed: Apr. 3, 2013
(86) PCT No.: PCT/EP2013/057002

§ 371 Date: Oct. 3, 2014

(30) Foreign Application Priority Data
Apr. 4, 2012 (DE) 10 2012 205 567.3

(51) Int. Cl. H02K 5/132; F04D 13/08

(52) U.S. Cl. CPC H02K 5/132; F04D 13/08; H02K 2201/03

(57) ABSTRACT

The present invention relates to a synchronous reluctance motor for an underwater pump having a stator and a rotor which comprises a fluid barrier section for fanning one or more magnetic pole pairs, wherein the airgap between the rotor (12) and the stator (II) is at least partially filled with a ferrofluid (20). A further partial aspect of the invention relates to an underwater pump with such a synchronous reluctance motor for driving the pump.

This application is National Stage of PCT International Application No. PCT/EP2013/057002, filed Apr. 3, 2013, which claims priority under 35 U.S.C. §119 from German Patent Application No. 10 2012 205 567.3, filed Apr. 4, 2012, the entire disclosures of which are herein expressly incorporated by reference.

### BACKGROUND AND SUMMARY OF THE INVENTION

The invention relates to a synchronous reluctance motor for driving an underwater pump, having a stator/rotor arrangement, the rotor comprising a flow barrier cut for forming one or more magnetic pole pairs. The invention relates, moreover, to an underwater pump having a drive motor of this type.

Underwater motor pumps serve for the conveyance of liquid media in boreholes. The housing outside of the motors is wetted completely or partially by the conveyed medium, usually groundwater. The pump drive motors used are of encapsulated form so as to prevent the conveyed medium from penetrating into the motor inner space.

The motor space is filled with suitable liquid medium, preferably with a water/glycol mixture or oil, which wets both the unprotected rotor and, in the case of an unprotected stator, the stator, together with plastic-insulated winding wires, or, in the case of a protected stator, a can. The medium introduced ensures that the motor has sufficient cooling capacity.

At the same time, the medium ensures constant lubrication of the hydrodynamic plain bearings and, under certain circumstances, affords a desirable corrosion-protecting action for the active parts.

As compared with air-filled motor spaces, however, the achievable efficiency and power factor of machines of this type are markedly reduced, since, inter alia because of the liquid medium in the motor space, the friction effect between the rotor and medium increases tremendously.

Underwater motor pump assemblies are installed in suitable boreholes in the region of the conveyed medium. The drilling costs vary as a function of the drilling depth and of the necessary borehole diameter. Just borehole depths of a few hundred meters incur enormous costs which are forestalled, for example, via restriction in the permissible borehole diameter.

However, limiting the maximum diameter places stringent requirements upon the development of the motor assemblies, since the physical dimensioning of the assembly, as a rule, critically codetermines its efficiency and power factor. In particular, the motor cross section has to be adapted to the desired borehole diameter.

So that sufficient shaft output can nevertheless be provided, the active part length of the motor has to be increased correspondingly. The very slender type of construction of the assembly associated with this causes the ratio of rotor length to rotor diameter to grow. The active part length of the rotor is in this case at least twice as large as the rotor diameter. For manufacturing reasons, therefore, a relatively large airgap has to be implemented which is markedly larger than in conventional motors. The airgap dimensions of underwater motors usually amounts to more than double the airgap dimensions of conventional motors.

However, it is especially desirable, precisely in assemblies which operate on the reluctance principle, to keep the airgap as small as possible. However, because the motor design in underwater motors is governed by their use, the use of synchronous reluctance motors in the underwater pump sector can be implemented at the present time only with considerable losses in terms of efficiency and of power factor.

The object of the invention, therefore, is to modify a known synchronous reluctance motor in which a way that it can be used even in an underwater pump, but without having to take into account appreciable losses in terms of efficiency and of power factor.

According to the present invention, a synchronous reluctance motor is proposed, which has a stator and a rotor operatively connected to the stator. The rotor comprises a flow barrier cut for forming one or more magnetic pole pairs.

Furthermore, the rotor of the synchronous reluctance machine may preferably be equipped with a cylindrical soft-magnetic element which is arranged coaxially on the rotor axis. To form at least one pole pair or gap pair, the soft-magnetic element preferably comprises flow guide and flow barrier sections which differ from one another in a differently pronounced magnetic permeability. The section having high magnetic conductivity is identified as the d-axis of the rotor and the section having comparatively lower conductivity is identified as the q-axis of the rotor. Optimal torque output is established when the d-axis has as high magnetic conductivity as possible and the q-axis has as low magnetic conductivity as possible.

This precondition can be achieved by the formation of a plurality of air-filled recesses in the soft-magnetic element along the q-axis.

In a preferred embodiment of the rotor according to the invention, the soft-magnetic element is a lamination bundle which is composed of a plurality of laminations stacked one on the other in the axial direction of the rotor. This type of construction prevents the occurrence of eddy currents in the soft-magnetic element. In particular, a construction of the lamination bundle according to the technical teaching of U.S. Pat. No. 5,818,140, to which express reference is made in this respect, is appropriate.

Due to the technical conditions explained above in underwater motor pumps, there is a comparatively large airgap between the rotor element and stator element. A geometric reduction in size of the airgap so as to counteract the associated power and efficiency losses is ruled out for the reasons mentioned above.

According to the invention, the filling medium used hitherto in the motor inner space is replaced by a ferrofluid. A suitable choice of the ferrofluid used results in a relative permeability of μ_{R}>1. The increase in permeability in the airgap corresponds in its effect to a geometric reduction of the magnetic airgap. The magnetically active airgap is correspondingly reduced in size. The higher the permeability value in the airgap is, the more advantageous the efficiency and power factor of the synchronous reluctance motor used become. The interaction between rotor and stator is reinforced. Certain motor principles can therefore be adopted even where the technical conditions dictate a comparatively large airgap.

The use according to the invention of a ferrofluid makes it possible to employ a synchronous reluctance motor for driving an underwater pump, having satisfactory efficiency and power factor.

At the same time, the fluid used improves the discharge of heat in the motor inner space. Moreover, hydrodynamic plain bearings are constantly lubricated, and the ferrofluid can have a corrosion-protecting action upon the active parts of the synchronous reluctance motor which are used.

The ferrofluid has one or more components which react to magnetism and which are magnetizable and, as a rule, superparamagnetic.

The magnetic components may be present in a different form in a carrier liquid. The combination of particles and of carrier liquid forms the ferrofluid.

One possibility is that the components are present as particles which are suspended in the carrier liquid. The individual particles are ideally suspended colloidally in the carrier liquid.

The particle size lies in the nano range, preferably between 1 nm and 10 nm, in particular particle sizes in the range of between 5 nm and 10 nm proving to be beneficial.

One or more particles is or are composed in a suitable way of at least one of the materials comprising iron, magnetide, cobalt or a special alloy.

The particles may be provided with a surface coating, particularly a polymeric coating. It is possible to admix a surface-active substance which adheres as a monomolecular layer to the surface of the particles. The radicals of polar molecules of the surface-active substance repel one another and thus prevent the particles from lumping together.

In order to keep the friction effect on the rotor within limits, it is expedient to use a low-viscosity ferrofluid. For example, the viscosity of the ferrofluid used lies in the region of that of water, that is to say in the region of approximately 1 mPa·s at 20° C.

However, using the ferrofluid entails an adverse concomitant phenomenon, since the increased permeability in the motor space also intensifies the leakage losses which occur. Contrary to air-filled motors, the propagation of the leaking flux lines is no longer inhibited, but instead is promoted, which is why the losses occurring increase considerably.

In order to counteract this effect, means may be provided in the region of at least one end winding of the stator in order to reduce the end leakage occurring. One or more elements are expediently arranged in this region in order to displace the ferrofluid in this region. Suitable elements are one or more plastic bodies which, preferably with an exact fit, can be attached around one or more end windings or can be slipped onto these. Alternative means for reducing the end leakage occurring are obtained by sealing the end windings or filling the space around the end windings with foam. In principle, materials with nonmagnetic properties are suitable.

A similar problem arises in the region of the slots of the stator body. Here, too, because of the ferrofluid, the flux lines can be propagated more easily and cause higher losses. Means in the region of the slots are expediently proposed which displace the ferrofluid out of this region and limit the leakage losses occurring. Keys which are inserted into one or more slots are especially advantageous.

The rotor of the synchronous reluctance machine is preferably composed of a laminated rotor bundle. The rotor bundle has individual flow barriers for forming one or more pole pairs. Flow barriers are formed in a way known per se by means of recesses in the rotor bundled which are usually filled with air. In this case, there is the risk that the ferrofluid infiltrates into the cavity of the flow barriers. In a preferred version of the invention, the rotor or at least part of the rotor is of encapsulated form so as to seal off the rotor body with respect to the ferrofluid.

Alternatively or additionally, one or more flow barriers may be sealed off separately and be protected against an undesirable ingress of liquid. It is also possible to fill the flow barriers with a suitable material, for example plastic, in order to prevent the ingress of liquid.

The invention relates, furthermore, to an underwater pump having a pump-driving synchronous reluctance motor according to the features of the motor according to the invention or of an advantageous embodiment of the synchronous reluctance motor. The underwater pump evidently has the same advantages and properties as the synchronous reluctance motor according to the invention or as an advantageous embodiment of the motor, and therefore a renewed description is dispensed with at this juncture.

Other objects, advantages and novel features of the present invention will become apparent from the following detailed description of one or more preferred embodiments when considered in conjunction with the accompanying drawings.

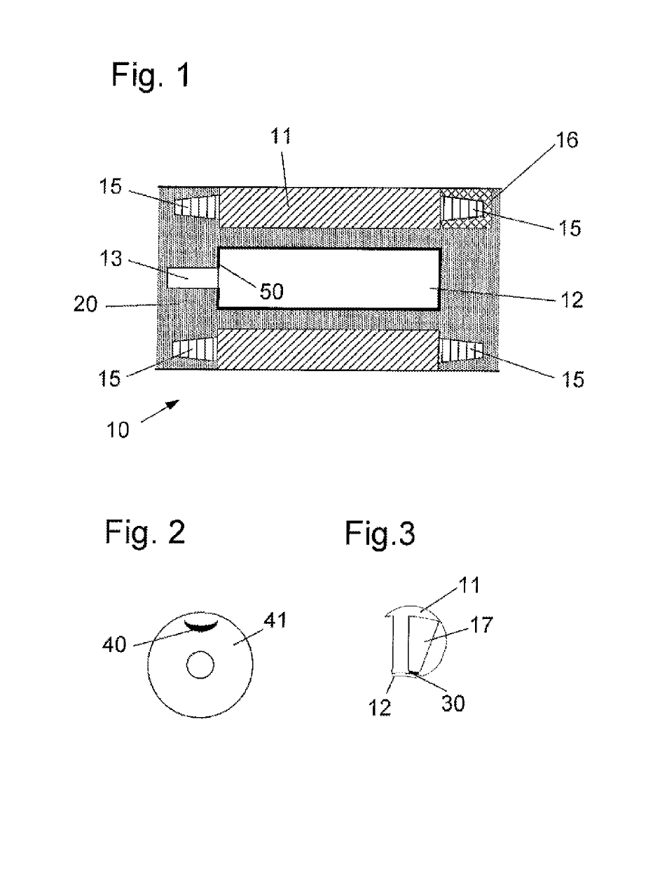

FIG. 1 shows a schematic longitudinal sectional illustration of an embodiment of a synchronous reluctance motor according to the invention,

FIG. 2 shows a schematic cross-sectional illustration of the rotor of FIG. 1, and

FIG. 3 shows a detail of the stator of the synchronous reluctance motor of FIG. 1.

### DETAILED DESCRIPTION

The synchronous reluctance motor 10 illustrated in FIG. 1 has a conventional stator 11 and a rotor 12 which is mounted rotatably with respect to the stator 11 and which is itself arranged coaxially on the shaft 13. The rotor body is composed of a laminated bundle, for example a lamination bundle, the individual layers or laminations being stacked in the axial direction of the shaft 13. A schematic illustration of an individual layer may be gathered from FIG. 2.

The clearance between the rotor wall and stator wall is designated as an airgap. According to the embodiment of the invention in FIG. 1, the motor inner space is filled with a ferrofluid 20, with the result that permeability in the region between the stator 11 and rotor 12 is increased and the comparatively large geometric clearance is compensated. The interaction between rotor 12 and stator 11, that is to say the reluctance force, is enhanced due to the increased permeability.

The ferrofluid 20 used is composed of magnetic particles which have the size of a few nanometers and which are suspended colloidally in a suitable carrier liquid. The viscosity properties of the ferrofluid 20 used are in this case selected such that the friction effect between the rotor and ferrofluid 20 is as low as possible. The ferrofluid 20 ideally has a viscosity of the order of the viscosity of water.

Leakage losses occurring in the region of the end windings 15 with the stator 11 are to be reduced as far as possible by means of one or more plastic bodies 16. The plastic body is attached to the corresponding end winding 15 and surrounds the latter for the complete displacement of the ferrofluid.

Moreover, the leakage losses occurring in the slot region of the stator 11 are reduced by means of keys 30. FIG. 3 shows a detail of a cross section through the stator bundle 11 with a winding space 17. In the region of the slot, a key 30 is provided, which displaces the ferrofluid in the slot in order to prevent a magnetic short circuit between the stator teeth.

FIG. 2 shows a cross section through the rotor bundle 12. The drawing illustrates schematically an individual flow barrier of a rotor layer 41. The otherwise air-filled recess 40 of the rotor layer 41 is filled or foam-filled completely with a plastic-like material in order to prevent the possible ingress of fluid.

Additionally or alternatively, the complete rotor body 12 may be of encapsulated form, as indicated in FIG. 1. For example, the rotor surface is coated completely with a suitable material 50 in order to protect the rotor body against the ingress of liquid.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. An underwater pump synchronous reluctance motor, comprising:
a stator; and
a rotor,
wherein
the rotor includes a flow barrier forming at least one magnetic pole pairs, and
an airgap between the rotor and the stator is at least partially filled with a ferrofluid.

12. The synchronous reluctance motor as claimed in claim 11, wherein
the ferrofluid comprises a carrier liquid carrying at least one magnetically-reactive component.

13. The synchronous reluctance motor as claimed in claim 12, wherein
at least one of the at least one magnetically-reactive components are particles suspended colloidally in the carrier liquid.

14. The synchronous motor as claimed in claim 13, wherein
the particle size of the particles is between 1 and 10 nm.

15. The synchronous motor as claimed in claim 13, wherein
the particle size of the particles is between 5 and 10 nm.

16. The synchronous reluctance motor as claimed in claim 11, wherein
a viscosity of the ferrofluid is approximately 1 mPa·s at 20° C.

17. The synchronous reluctance motor as claimed claim 11, further comprising:
end leakage reducing elements arranged adjacent to stator end windings of the stator.

18. The synchronous reluctance motor as claimed 11, further comprising:
at least one slot leakage reducing key arranged at at least one slot in the stator.

19. The synchronous reluctance motor as claimed in claim 11, wherein
the rotor is encapsulated.

20. The synchronous reluctance motor as claimed claim 11, wherein
the rotor includes at least one rotor flow barrier that is at least one of sealed and filled.

21. An underwater pump, comprising:
a pump member; and
an underwater pump synchronous reluctance motor having a stator and a rotor,
wherein
the pump member is arranged to be driven by the synchronous reluctance motor, the rotor includes a flow barrier forming at least one magnetic pole pairs, and an airgap between the rotor and the stator is at least partially filled with a ferrofluid.
